(19) United States
(12) Patent Application Publication
(10) Pub. No.: US 2015/0175352 A1
(43) Pub. Date: Jun. 25, 2015

(54) GARBAGE CAN LID RETENTION DEVICE AND METHODS

(71) Applicant: Michael JACOBSON, (US)

(72) Inventor: Michael Jacobson, Merrick, NY (US)

(21) Appl. No.: 14/411,799

(22) PCT Filed: Jun. 27, 2013
(86) PCT No.: PCT/US2013/048134

§ 371 Date: Dec. 29, 2014

Related U.S. Application Data
(60) Provisional application No. 61/670,363, filed on Jul. 11, 2012.

(51) Int. Cl. B65F 1/16

(52) U.S. Cl. CPC B65F 1/16; B65F 2001/1653

(57) ABSTRACT

The present invention relates to devices and methods for coupling the lid of a trash can to the body of a trash can. The device of the invention comprises an elongated tether with a first end and second end, the first end and the second end of the elongated tether terminate in loops capable of engaging with connectors to mount the ends of the tether to the lid and body of a trash can. The invention also comprises methods of coupling the lid portion of a trash can to the body portion of a trash can using the device of the present invention.

### FIELD OF THE INVENTION

The present invention relates to accessories for garbage cans or other containers having removable lids or covers. Particularly the invention disclosed relates to a lid retention device formed by an elongated strap or cord that tethers the lid of a trash can to the body of the trash can.

### BACKGROUND OF THE INVENTION

Trash cans are a ubiquitous part of society. Many if not all households are equipped with several trash cans that are used to store household trash before permanent disposal. One problem that occurs frequently is that the lids of trash cans are lost. This can happen either by the action of wind or other weather phenomena. What's more, animals seeking food in human trash, may remove the lids of trash cans to get at what is inside resulting in loss of the trash can lid. Regardless of the cause, the misplacement of trash can lids is a vexatious problem. A trash can without a lid is more susceptible to spilling or rifling by animals. Further, a trash can without a lid may be the source of unpleasant odors. Additionally, a trash can lid on the ground may be stepped on or otherwise damaged or lost. It is therefore a goal of the present invention to reliably fix the lid of a trash can to the body of a trash can.

### SUMMARY OF THE INVENTION

In an embodiment the invention is a device for connecting the lid of a trash can to the body of a trash can. The device comprises a elongated tether with a first end and second end, the first end and the second end of the elongated tether terminate in loops capable of engaging with connectors to mount the ends of the tether to the lid and body of a trash can.

In an embodiment, the invention is a trash can comprising a body portion and a lid portion where the lid portion is coupled to the body portion with a tether, the tether further comprising a first end and a second end, where the first and second ends of the tether terminate in loops. The first end of the tether may be attached to the lid portion of a trash can with a connector capable of engaging the lid portion of the trash can and the loop portion of the tether. The second end of the tether may be attached to the body portion of the trash can with a connector capable of engaging the body portion of the trash can and the loop portion of the tether.

In an embodiment, the invention is a method of coupling the lid of a trash can to the body of a trash can with a tether, the tether further comprising a first end and a second end, where the first and second ends of the tether terminate in loops. The method comprising the steps of connecting the first end of the tether to the lid portion of a trash can and connecting the second end of the tether to the body portion of a trash can.

In an embodiment, the invention is a kit providing a device for connecting the lid of a trash can to the body of a trash can. The device comprises a elongated tether with a first end and second end, the first end and the second end of the elongated tether terminate in loops capable of engaging with connectors to mount the ends of the tether to the lid and body of a trash can. The kit further comprises connectors to connect the ends of the tether to the lid and body of a trash can and a tool for forming holes in the lid and body of a trash can. In another embodiment, the invention provides a method

### BRIEF DESCRIPTION OF THE DRAWINGS

FIG. 1: Shows the elongated tether of the present invention

FIG. 2: Shows a trash can incorporating the device of the present invention

FIG. 3: Illustrates connecting the device of the present invention to the lid or body of a trash can

FIG. 4: Shows some examples of suitable connectors

FIG. 5: Shows the device in operation

FIG. 6: Illustrates the components of a kit of the present invention

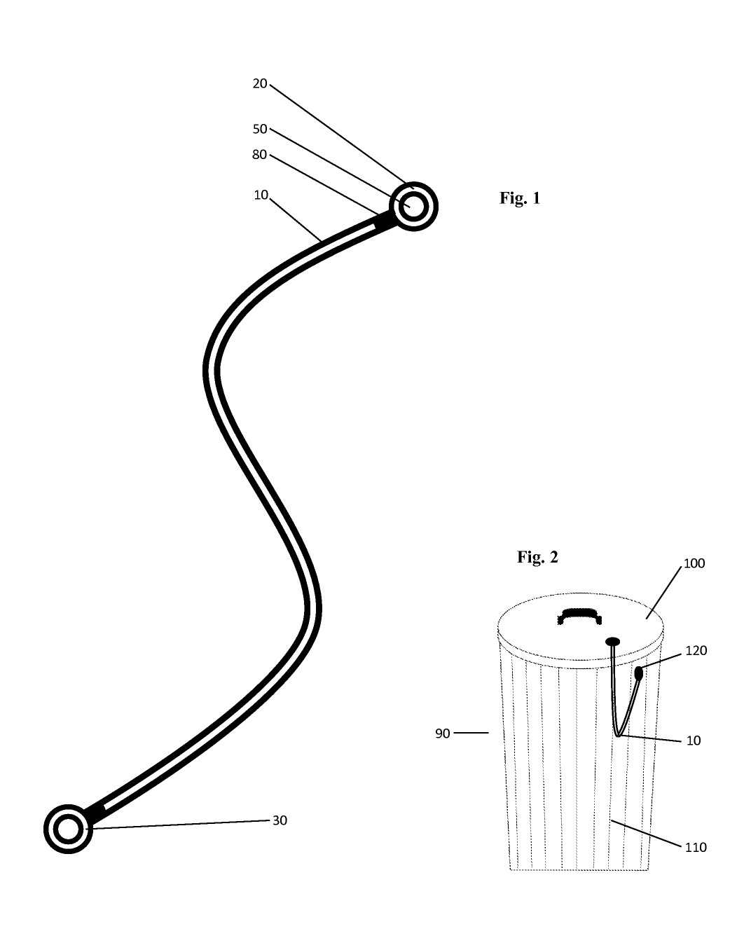

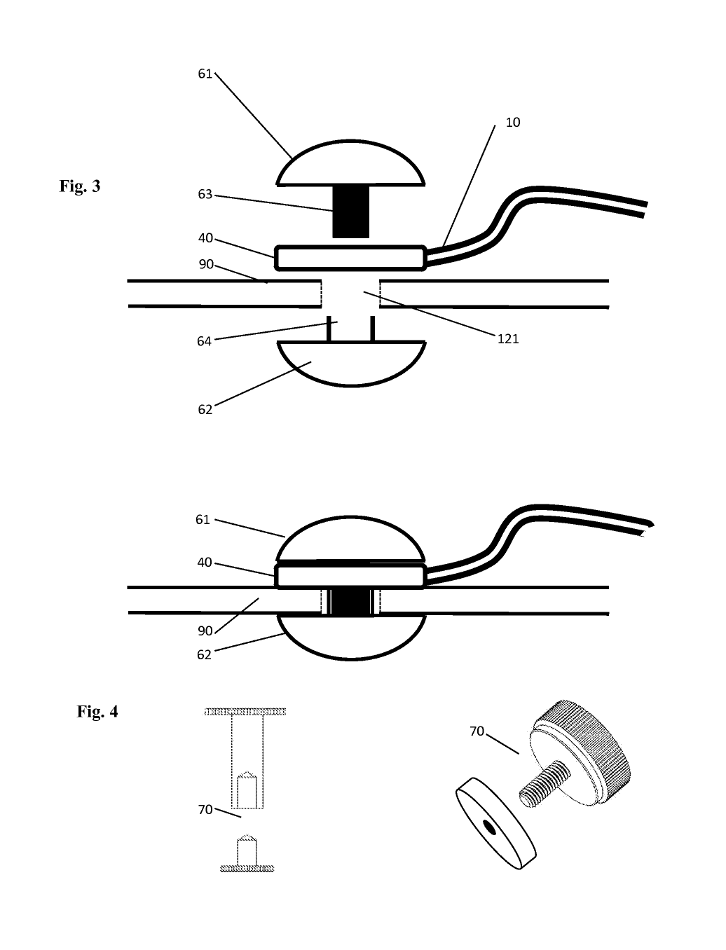

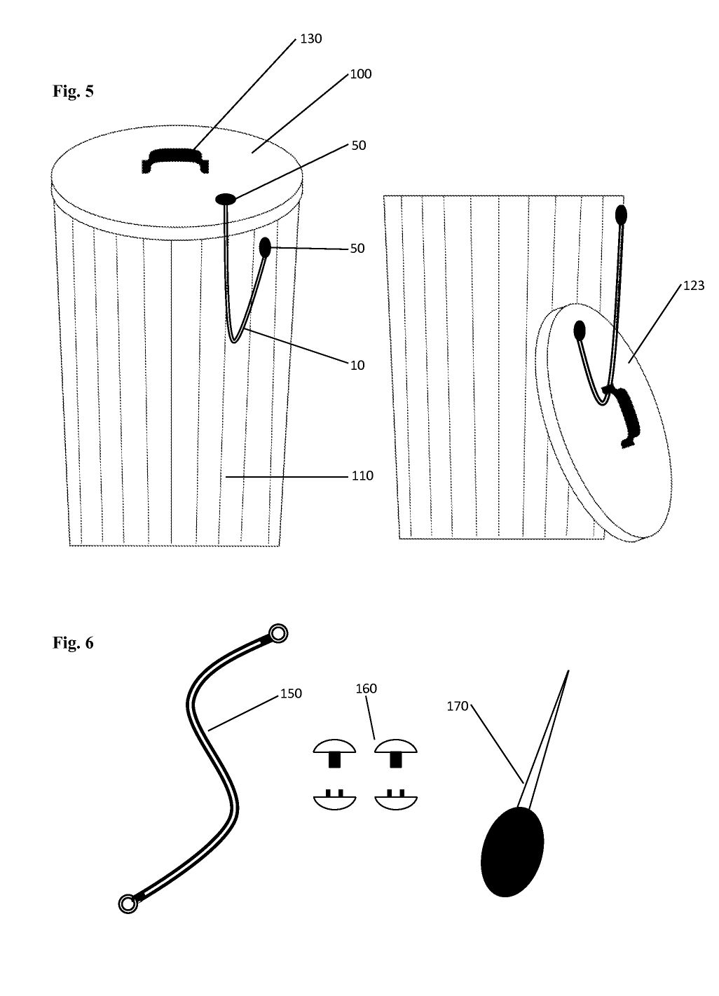

### DETAILED DESCRIPTION OF THE INVENTION

In an embodiment the invention is a device for connecting the lid of a trash can to the body of a trash can. The device comprises a elongated tether (10) with a first end (20) and second end (30), the first end and the second end of the elongated tether terminate in loops (40) capable of engaging with connectors to mount the ends of the tether to the lid (100) and body (110) of a trash can (90).

In an embodiment, the invention is a trash can (90) comprising a body portion (110) and a lid portion (100) where the lid portion is coupled to the body portion with a tether (10) further comprising a first end (20) and a second end (30), where the first and second ends of the tether terminate in loops (40). The first end of the tether may be attached to the lid portion of a trash can with a connector (50) capable of engaging the lid portion of the trash can and the loop portion of the tether. The second end of the tether may be attached to the body portion of the trash can with a connector capable of engaging the body portion of the trash can and the loop portion of the tether.

In an embodiment, the invention is a method of coupling the lid of a trash can to the body of a trash can with a tether, the tether further comprising a first end and a second end, where the first and second ends of the tether terminate in loops. The method comprising the steps of connecting (120) the first end of the tether to the lid portion of a trash can and connecting the second end of the tether to the body portion of a trash can. The method may further comprise the step of forming holes (121) in the lid and body portions of a trash can. The connecting steps may further comprise the steps of inserting (122) an elongated portion (63) of the top portion of a connector (61) through the looped end of the tether (40), inserting the elongated portion of the top portion of the connector (63) through a hole (121) in the lid of the trash can, and coupling the bottom portion of the connector to the top portion of the connector. This step will be repeated for coupling the other end of the tether to the body portion of the trash can.

In an embodiment, the invention is a kit (140) providing a device for connecting the lid of a trash can to the body of a trash can. The device comprises a elongated tether with a first end and second end, the first end and the second end of the elongated tether terminate in loops capable of engaging with connectors to mount the ends of the tether to the lid and body of a trash can (150). The kit further comprises connectors (160) to connect the ends of the tether to the lid and body of a trash can and a tool (170) for forming holes in the lid and body of a trash can.

### The Tether

The tether of the present invention may be made from any substantially flexible material known to those skilled in the art. Because it is anticipated that the invention will be used outside, it may be desirable for the tether to be of suitably rugged material to survive exposure to the elements and still maintain its flexibility and structural integrity. Materials specifically contemplated include but are not limited to synthetic cord or rope, natural fiber rope or cord, braided steel cable and the like. The tether further comprises a first end and second end (“the ends.”) The ends of the tether may be folded back on themselves and secured in place, as in, for example with crimping bands (80), to form loops (40) that will be used in conjunction with the connectors to couple the tether to the lid and body of the trash can respectively.

### The Trash Can

The invention of the present disclosure may incorporate any trash can known to those skilled in the art. The trash can may be made of any material, as in, for example, metal, plastic, rubber or the like. The trash can further comprises a body portion (110) adapted for holding trash or other material, and a lid portion (100) adapted to fit onto the body portion of the trash can. The lid may further comprise a handle (130) to aid in removing and replacing the lid.

### Connectors

The invention of the present disclosure may utilize any suitable connector capable of connecting the tether to the lid and body portions of the trash can respectively. The connectors may further comprise a top portion (61) and a bottom portion (62) and may further comprise at least one elongated element (63) and a receiving element (64). The top and bottom portions of the connectors are adapted to be coupled together, as in, for example, by screwing or snapping together. An example of a connector that would be suitable is a rivet (60), possibly a plastic rivet. The use of rivets, placed by a user in a desired location, is an advantage of the present invention because it would not interfere with the use of a handle that may be attached to the lid. An example of a rivet that may be suitable is the Tuflok (R) brand plastic rivet which is a one-piece fastener with a pre-driven pin that is capable of easy installation by hand or with automatic equipment. It is ideally suited for any application requiring a front mount, removable, reusable push-type plastic rivet where a dependable connection is required. Other connectors that may be suitable are male-female screws (70) which may further comprise knurled heads or knob heads. While these are illustrative examples, those skilled in the art would recognize that there are a variety of suitable connectors that would be able to reliably connect the tether to the trash can body and lid.

### Coupling the Tether to the Trash Can

In order to use the device, a small hole (121) should be made at the location where the tether is to be connected. In some cases the hole may be made with an awl (170) or other suitable device which may be included with the garbage can lid retention device. Once the hole in the trash can body and trash can lid have been formed, the tether of the retention device is fixed to the body and lid of the trashcan such that the tether becomes a means of connecting the lid of the trash can to the body of the trash can. The connection may be made by inserting (122) the elongated portion (63) of the top portion (61) of the connector through the looped end (40) of the tether (10) and through the hole (121) in the lid of the trash can (100). The bottom portion (62) of the connector (50) can then be attached so as to couple the tether to the trash can. This process can be repeated with the other end of the tether and the body of the trash can. In such a configuration, the lid of the trash can would remain connected (123) to the body of the trash can for convenient use. It should also be noted that some trash cans come equipped with pre-drilled holes on either the lid or body of the trash can. Trash cans so equipped would not require additional holes to be formed.

### The Kit

In an embodiment, the invention is a kit (140) providing a device for connecting the lid of a trash can to the body of a trash can. The device comprises a elongated tether with a first end and second end, the first end and the second end of the elongated tether terminate in loops capable of engaging with connectors to mount the ends of the tether to the lid and body of a trash can (150). The kit further comprises connectors (160) to connect the ends of the tether to the lid and body of a trash can. The connectors may further comprise a top portion and a bottom portion and may further comprise at least one elongated element. The top and bottom portions of the connectors are adapted to be coupled together, as in, for example, by screwing or snapping together. An example of a connector that would be suitable is a rivet, possibly a plastic rivet. The use of rivets, placed by a user in a desired location, is an advantage of the present invention because it would not interfere with the use of a handle that may be attached to the lid. An example of a rivet that may be suitable is the Tuflok (R) brand plastic rivet which is a one-piece fastener with a pre-driven pin that is capable of easy installation by hand or with automatic equipment. It is ideally suited for any application requiring a front mount, removable, reusable push-type plastic rivet where a dependable connection is required. Other connectors that may be suitable are male-female screws which may further comprise knurled heads or knob heads. While these are illustrative examples, those skilled in the art would recognize that there are a variety of suitable connectors that would be able to reliably connect the tether to the trash can body and lid. The kit further comprises a tool (170) for forming holes in the lid and body of a trash can such as an awl or hole punch.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein, including all patents, published patent applications, and published scientific articles, are incorporated by reference in their entireties for all purposes.

What is claimed is:

1. A garbage can lid retention device comprising:
an elongated tether with a first end and a second end;
the first and second ends of the tether each further comprising a loop;
a connector coupled to the first end of the elongated tether capable of connecting the elongated tether to a lid of a trash can; and
a connector coupled to the second end of the elongated tether capable of connecting the elongated tether to a body of a trash can.

2. The device of claim 1 where the connectors coupled to the first end and the second end of the elongated tether are rivets.

3. The device of claim 1 where the connectors coupled to the first end and the second end of the elongated tether are male-female screws.

4. The device of claim 1 where the elongated tether is made of rope.

5. The device of claim 1 where the elongated tether is made of cord.

6. The device of claim 1 where the loops at the first and second ends of the tether are formed by folding and fastening the material of the tether back onto itself.

7. A garbage can comprising a lid portion and a body portion wherein the lid portion is coupled to the body portion by an elongated tether, the elongated tether further comprising a first end a second end, the first and second ends of the tether each further comprising a loop, and wherein the ends of the elongated tether are coupled to the lid portion and body portion of the trash can with rivets that pass through the loops at the ends of the elongated tether.

8. A method for coupling a lid portion of a trash can to a body portion of the trash can using the device of claim 1 comprising the steps of coupling the first end of the elongated tether to the lid of the trash can, and coupling the second end of the elongated tether to the body of the trash can.

9. The method of claim 8 wherein the coupling step further comprises the steps of forming a hole in the lid portion of the trash can, forming a hole in the body portion of the trash can, and riveting the first and second ends of the elongated tether to the lid portion and body portion of the trash can through the holes.

10. A kit comprising
an elongated tether with a first end and a second end, the first and second ends of the tether each further comprising a loop;
at least 2 connectors capable of coupling the first and second ends of the tether to a trash can; and
a tool capable of forming a hole in a lid and a body of a trash can.

11. The kit of claim 10 where the tool capable of forming a hole in the lid and body of a trash can is an awl.
